(19) United States
(12) Patent Application Publication
(10) Pub. No.: US 2003/0128742 A1
(43) Pub. Date: Jul. 10, 2003

(54) Post processing of spreading codes in a mobile telecommunications system

(76) Inventor: David Johnson, Hampshire (GB)

Correspondence Address: CROWELL & MORING LLP, INTELLECTUAL PROPERTY GROUP, P.O. BOX 14300, WASHINGTON, DC, 20044-4300, US

(21) Appl. No.: 10/220,337

(22) PCT Filed: Feb. 28, 2001
(86) PCT No.: PCT/GB01/00846

(30) Foreign Application Priority Data
Mar. 1, 2000 (GB) 0004790.2

(51) Int. Cl. H04B 1/69; H04B 1/707

(52) U.S. Cl. 375/147

(57) ABSTRACT

In mobile telecommunications systems, such as UMTS, user communications can be transmitted in parallel within a single timeslot by spreading the different user communications amongst a plurality of orthogonal spreading codes. Each spreading code has a characteristic spreading factor. The communications transmitted in each timeslot are joint detected and de-spread into the original user communications by a joint detection algorithm. There is provided a method of post-processing the results of the joint detection algorithm when the spreading factors are unknown. The method of post-processing operates without the need to apply the joint detection algorithm more than once. Consequently, spreading codes with different spreading factors can be used in one timeslot

The present invention relates to a method of post-processing the results of a joint detection algorithm with unknown spreading factors in mobile telecommunications systems. In particular, the method of post-processing operates without the need to apply the joint detection algorithm more than once.

The third generation mobile radio telecommunications system, UMTS, as specified by the Third Generation Partnership Project (3GPP) has two defined modes, frequency division duplex (FDD) and time division duplex (TDD). UMTS is an acronym for universal mobile telecommunication system as will be understood by persons skilled in the art.

The UMTS terrestrial radio access time division duplex (UTRA TDD) mode is based on a combination of code division multiple access (CDMA) and hybrid time division multiple access (TDMA). Communications from a given user of a telecommunications system in UTRA TDD mode are separated from communications from other users by dividing the communication into a sequence of timeslots and codes. The communication transmitted in any timeslot by the given user can be superimposed across communications from other users by multiplying the signal from each user by a respective binary sequence, known as a spreading code. Binary sequences suitable for use as spreading codes have a higher data rate than the communications signal and are mutually independent and ultimately separable. The higher data rate bits of spreading codes are known as a chips.

In the process of receiving a transmission within a given timeslot, the spreading-coded user communications transmitted within the given timeslot are detected together. Simultaneous or joint detection is advantageous as it gives a better error rate performance than detecting spreading-coded communications one code at a time. The communications transmitted in the given timeslot contain information encoded by a plurality of spreading codes. The original user communications are reconstructed from the joint detected spreading-coded communication in a process known as despreading. Suitable algorithms for de-spreading include the joint detection algorithm (JD).

The JD algorithm requires that all spreading codes have the same spreading factor, SF. The spreading factor can be considered as a measure of the length of the spreading code, in chips. However the 3GPP specification for TDD uses real Orthogonal Variable Spreading Factor (OVSF) codes for the channelisation spreading codes. Spreading factors of 2, 4, 8 or 16 can be selected from a spreading code tree.

A given spreading code can be used in a timeslot if and only if no other spreading code on the path from the given spreading code to the root of the tree (lower spreading factor) or in the sub-tree below the specific code is used in this timeslot (higher spreading factor).

In the uplink, a base station (BS) will know the spreading code allocation for each user equipment (UE) that is received in each timeslot. However the UE can choose to use a larger SF if a reduced data rate is required. Hence the BS may not know the SF of all the received spreading codes. Furthermore, in the downlink, the SF of the spreading codes allocated to a given UE are known to the given UE, however the SF of the spreading codes allocated to other users will not be known.

When the spreading factor is unknown, the original user communications can be despread by applying the JD algorithm under the assumption that all received spreading codes have the same spreading factor then repeating the algorithm for spreading codes of progressively lower spreading factor until every original user communication of whatever spreading factor has been despread. The repeated application of the JD algorithm is computationally intensive, time consuming and cumbersome.

It is the object of the present invention to obviate or at least mitigate the problem outlined above.

In accordance with the present invention, there is provided a method for despreading encoded transmissions using a plurality of spreading codes of unknown spreading factors, the method including the steps of selecting an initial spreading factor and applying the initial spreading factor to a joint detection algorithm in order to generate a first data symbol vector; the method being characterised by further including the steps of: post-processing the first data symbol vector at least once in order to determine the correct spreading factor for each of the plurality of spreading codes; and despreading the encoded transmissions according to the spreading factors determined.

Preferably, in the post-processing step a current spreading factor is set to be the initial spreading factor, a current data symbol vector is set to be the first data symbol vector, and values for a first threshold and for a second threshold are chosen, the post-processing step further includes the following steps:

i) testing the magnitudes of elements of the current data symbol vector against the first threshold;

ii) for each spreading code, making a count of the number of elements of the first data symbol vector having magnitudes below the first threshold;

iii) creating a histogram, wherein each category corresponds to a given spreading code and wherein a value in each category corresponds to the count for the given spreading code;

iv) testing the values for each category of the histogram against the second threshold, whereby if the count for the given spreading code is less than the second threshold, the current spreading factor is determined to be the correct spreading factor for the given spreading code; and

v) if at least one count is greater than the second threshold, the following additional steps are taken: changing the current spreading factor to a subsequent spreading factor; generating the current data symbol vector from the first data symbol vector, the generation being dependent upon the subsequent spreading factor; and repeating steps iii) to v) until all spreading factors are determined.

Since the reiterated post-processing step operates on the output of the JD algorithm using the initial spreading factor, the computationally intensive JD algorithm does not need to be applied repeatedly.

Preferably, the subsequent spreading factor is lower than the initial spreading factor. Equally preferably, the initial spreading factor is sixteen.

Preferably, the post-processing step c) further includes: checking whether each pair of spreading codes in the plurality of spreading codes has the same spreading factor and if different spreading factors are indicated for a given pair of spreading codes, assuming that only the lower spreading factor was transmitted.

Preferably, the method is stored as software upon a computer storage device.

In a further aspect of the invention there is provided an apparatus for despreading encoded transmissions using a plurality of spreading codes of unknown spreading factors, the apparatus including: a joint detection means, wherein a joint detection algorithm is applied to the encoded transmissions with an assumed initial spreading factor, the joint detection means generating a first data symbol vector; a post-processing means, wherein the first data symbol vector is post-processed in order to determine the correct spreading factor for each of the plurality of spreading codes; and a decoding means, wherein the encoded transmissions are despread according to the spreading factors determined.

Preferably, the post-processing means comprises: an initialising means, which: sets a current spreading factor to be the assumed initial spreading factor; sets a current data symbol vector to be the first data symbol vector; and sets the values for a first threshold and for a second threshold; a means for testing the magnitudes of elements of the current data symbol vector against the first threshold; for each spreading code, means for making a count of the number of elements of the first data symbol vector having magnitudes below the first threshold; means for creating a histogram, wherein each category corresponds to a given spreading code and wherein the value in each category corresponds to the count for the given spreading code; means for testing the values for each category of the histogram against the second threshold, whereby if the count for the given spreading code is less than the second threshold, the testing means determines that the current spreading factor is the correct spreading factor for the given spreading code; and if a given count is greater than the second threshold, the testing means determines that the current spreading factor is not the correct spreading factor for the spreading code corresponding to the given count.

Preferably, the post-processing means further comprises: means for changing the current spreading factor to a subsequent spreading factor; and means for generating the current data symbol vector from the first data symbol vector, the generation being dependent upon the subsequent spreading factor.

Preferably, the subsequent spreading factor is lower than the initial spreading factor. Equally preferably, the initial spreading factor is sixteen.

Preferably, the post-processing means further includes: means for checking whether each pair of spreading codes in the plurality of spreading codes has the same spreading factor and, if different spreading factors are indicated for a given pair of spreading codes, for assuming that only the lower spreading factor was transmitted.

Advantageously, the post-processing means is implemented as software stored upon a conventional storage device for use in a conventional processing device. Preferably, the joint detecting means is implemented as software stored upon a conventional storage device for use in a conventional processing device.

For a better understanding of the present invention, reference will now be made, by way of example only, to the accompanying drawings in which:

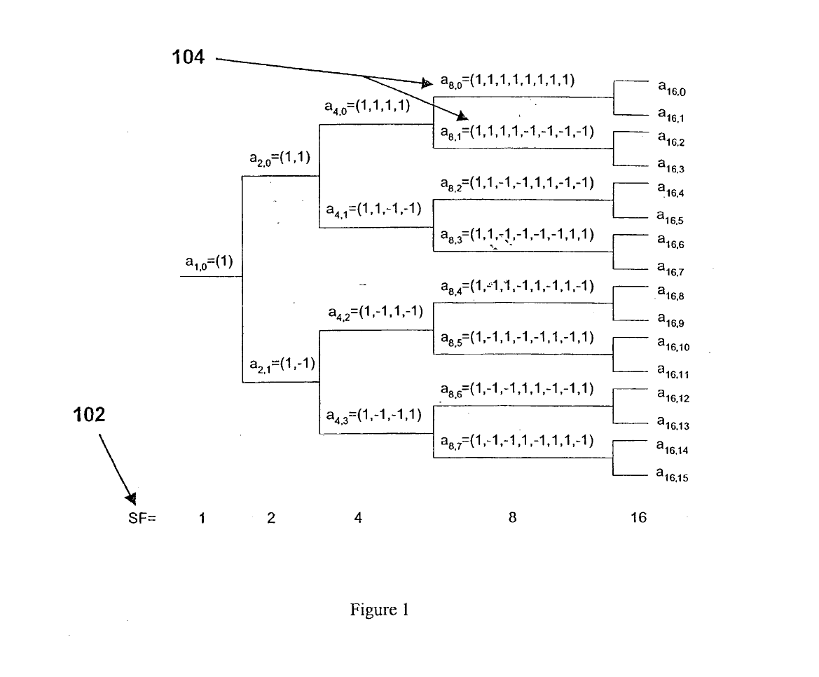

FIG. 1 shows the OVSF code tree;

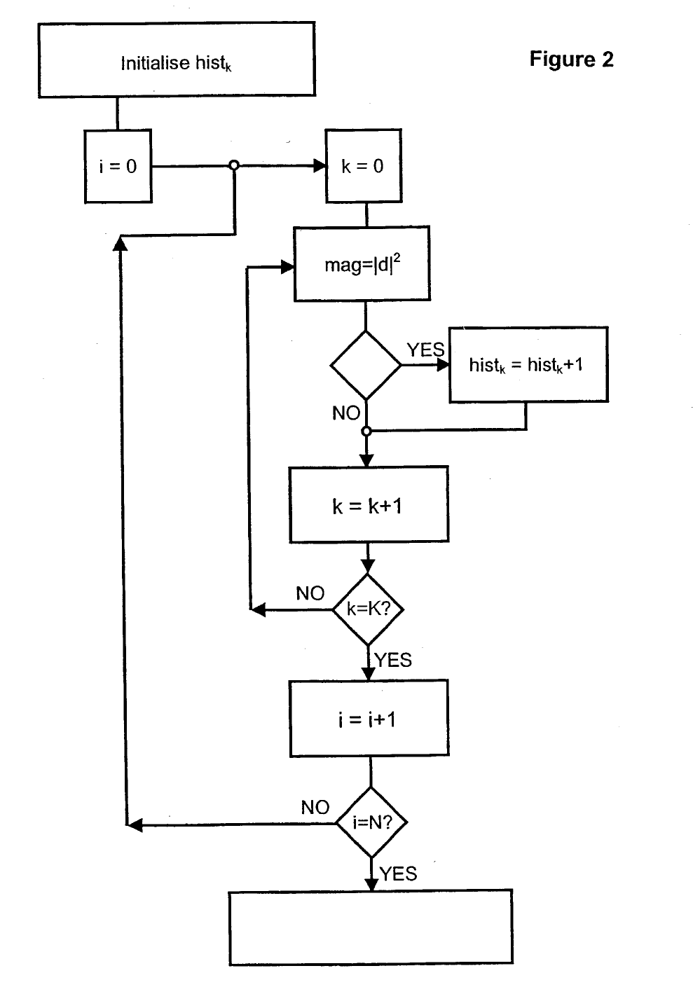

FIG. 2 shows a flow diagram of the post-processing method of the present invention;

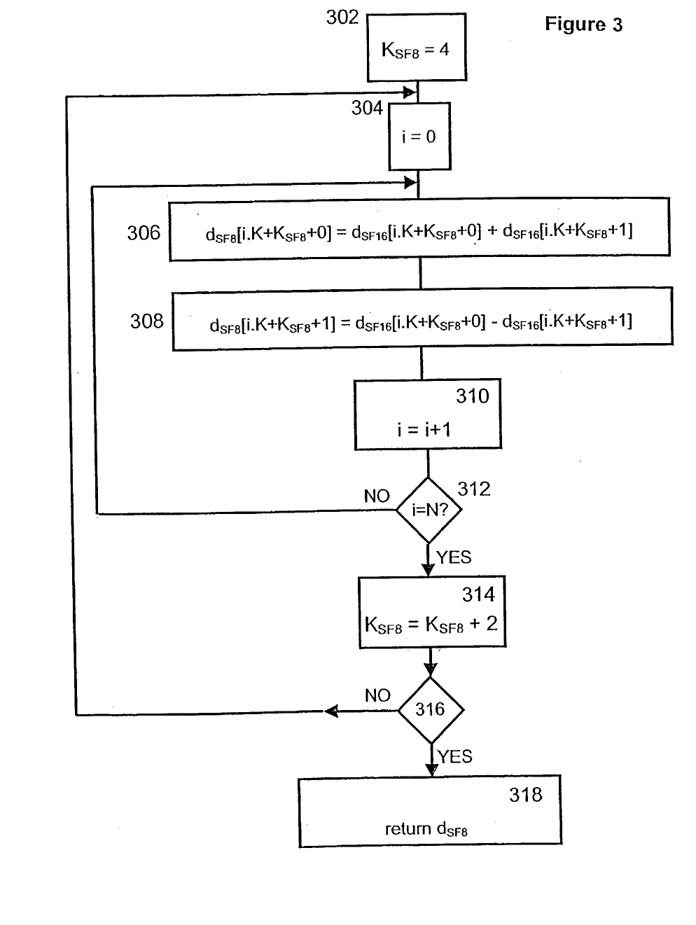

FIG. 3 shows a flow diagram of the generation of a soft data symbol vector for SF 8; and

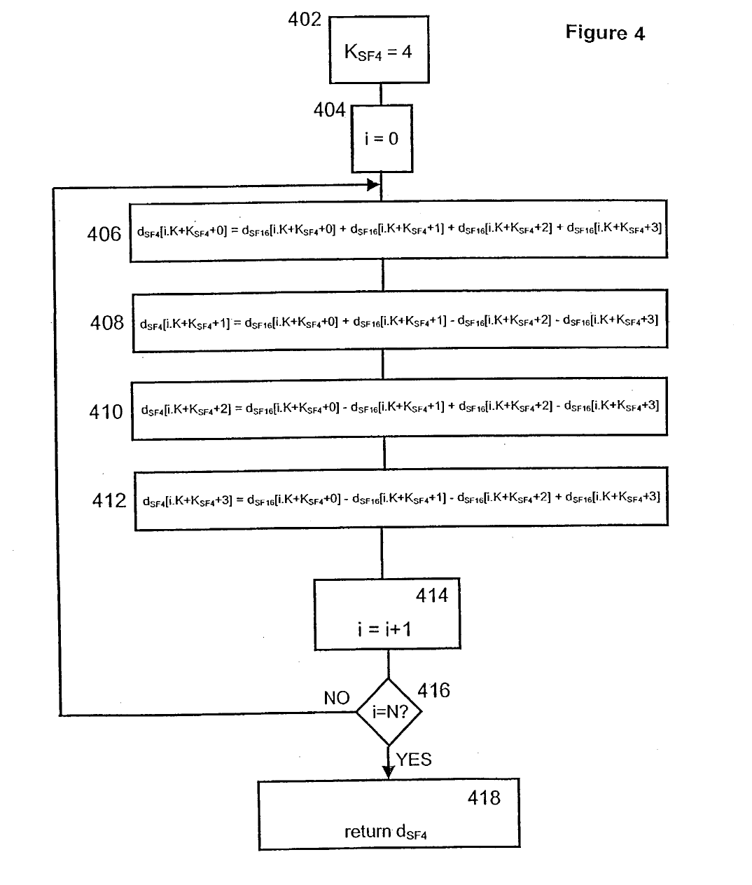

FIG. 4 shows a flow diagram of the generation of a soft data symbol vector for SF=4.

In FIG. 1, the spreading codes, a_{SF,i}, are shown in context of the OVSF code tree. In proceeding from left to right, the code tree steps up to higher SF 102. Each spreading code branch gives rise to two further spreading code branches to the right and the two further branches can be considered as a pair 104. Pairs of spreading codes 104, a_{SF,{even}} and a_{SF,{even+1}}, have the property of sharing the same first halves (equivalent to the parent spreading code branch, a_{SF/2,i}) and having second halves which are respectively a repeat of the first half and the inverse of the first half.

In a first embodiment of the present invention, the quadrature phase shift keying (QPSK) scheme for transmitting bits of information as waveforms is adopted. QPSK allows four possible waveforms (or constellation points) giving two bits of information. Each QPSK waveform is a data symbol representing a complex pair of bits.

The output of a JD algorithm is the soft estimate of the QPSK data symbols on each spreading code. In the absence of noise or distortion, the data symbols are the QPSK constellation points. The soft estimate data symbols are post-processed to determine the SFs of the transmitted spreading codes.

First, the standard JD algorithm operates with the assumption that all the spreading codes have a spreading factor of sixteen. The JD algorithm produces a one-dimensional array, or vector, of soft estimate data symbols d_{SF16}. The JD algorithm output vector has the following form: [symbol0:code0, code1, code2, . . . ; symbol1:code0, code1, . . . ; .etc.] where each of the spreading codes, codei, correspond to an SF=16 spreading code on the OVSF tree, a_{16,i}.

Secondly, the magnitudes of elements of the soft data symbol vector are tested against a predetermined threshold, thresh₁, as shown in FIG. 2. A vector of counters, histₖ, having length K, is initialised, block 202. The test takes place in a nested set of for loops:—for (i=0; i=i+1; i=N), blocks 204, 218 and 220 and for (k=0; k=k+1; k=K), blocks 206, 214 and 216. Thus, for each of the N data symbols and for each of the K available spreading codes, the magnitude of each soft estimate of the QPSK data symbol, d_{SF16}, is calculated, block 208, and on every occasion where that magnitude is less than the predetermined threshold, thresh₁, block 210, the appropriate element of the counter vector is incremented (histₖ=histₖ+1), block 212. The elements of the counter vector represent the number of times the magnitude of each estimate for each spreading code is below the predetermined threshold, thresh₁. The counter vector results in a histogram of occurrences of below-threshold magnitudes for each spreading code, histogram, block 222.

Thirdly, the elements of the counter array are tested against a second threshold, thresh₂, say N/4. Thus if the count for each spreading code is greater than the second threshold it can be assumed that the SF is lower than the initial assumption.

Fourthly, pairs of spreading codes are tested. If a first code of a given pair of spreading codes has a large number of small symbol magnitudes while the second code of the pair does not then it can be inferred that no transmission was made using the first spreading code. Only the second code of the pair was transmitted.

Taking as an example the case of histogram=(0, 0, 0, 0, 27, 21, 24, 24), where K=8 and N=60, thus thresh₂=N/4=15. The fifth, sixth, seventh and eighth elements of histogram indicate that the corresponding codes (code4, code5, code6 and code7) have a significant number of small magnitude symbols. It will therefore be assumed that the SF on the corresponding codes must be lower than 16. The elements of histogram are in pairs, implying that both codes in each pair were transmitted.

Fifthly, for those codes where a lower SF is indicated it is assumed that the SF is 8. It is noted that one data symbol at SF=16 has the same duration as two data symbols at SF=8. The data symbols in the SF=8 codes can be obtained by combining the soft data symbols on the two SF=16 codes that have been joint detected. So, for example, it can be assumed that softsymbol0 is code0+code1 and softsymbol1 is code0−code1. Addition and subtraction works because pairs of SF=16 spreading codes, say a_{16,4} and a_{16,5}, in the OVSF tree have the property of sharing the same first halves (equivalent to the SF=8 spreading code, a_{8,2}) and having second halves which are respectively a repeat of the first half (a_{8,2}) and the inverse of the first half (a_{8,2}⁻¹). When chip-wise addition is computed for adjacent code pairs the sum in the first half is double and the second half is zero. On the other hand, when a chip-wise subtraction is computed for adjacent code pairs the sum in the first half is zero and the second half is double. This effect can be seen in Table 1, where the chip-wise addition of code4, a_{16,4}, with code5, a_{16,5}, and the chip-wise subtraction of code5, a_{16,5}, from code4, a_{16,4}, are illustrated.

TABLE 1

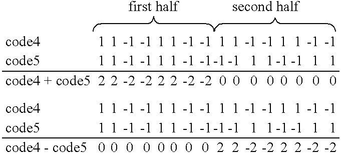

Adding and subtracting the soft symbols themselves has the same effect: here the chips in each code have been summed together first. Whether by chip-wise addition and subtraction or by adding and subtracting the soft symbols themselves, soft data symbols for a SF=8 are obtained.

The process for determining the SF=8 data symbols makes use of the effects of addition and subtraction as described above.

A new data symbol vector for SF=8, d_{SF8}, is initialised to be identical to the data symbol vector generated by the JD algorithm for SF=16, d_{SF16}. FIG. 3 shows how the new vector, d_{SF8}, is generated from d_{SF16}, in the case where the fifth, sixth, seventh and eighth elements of the histogram indicate that the corresponding codes have a significant number of small magnitude symbols.

The definition of the elements of the new vector, d_{SF8}, takes place within nested for loops:—for (K_{SF8}=4; K_{SF8}=K_{SF8}+2; K_{SF8}=6), blocks 302, 314 and 316, and for (i=0; i=i+1; i=N), blocks 304, 310 and 312. For each spreading code pair where a lower SF is indicated and for each soft data symbol, the even indexed elements of d_{SF8} are defined to be the sum of elements of d_{SF16} on each of the spreading codes belonging to the spreading code pair, block 306, and the odd elements of d_{SF8} are defined to be the difference between the elements of d_{SF16} on each of the spreading codes belonging to the spreading code pair, block 308.

A new histogram is created for the new soft symbol vector. Just as was done in the SF=16 stage, the new histogram is processed to discover the number of symbols using each code which have below-threshold magnitudes.

If all the elements of the new histogram fall below the second threshold, the process can stop as the assumption of SF=8 will be correct. If, on the other hand, the elements of the new histogram are above the threshold it must be assumed that the SF is lower still.

Considering the example once more, a further iteration would be necessary if the new histogram has the form (0, 0, 0, 0, 31, 30, 30, 31). Just as two codes were joint detected as one code when SF=8 was assumed, the process for SF=4 gives four codes which are joint detected as one code. To separate out each data symbol, the following set of combinations must be performed:

softsymbol0=code0+code1+code2+code3

softsymbol1=code0+code1−code2−code3

softsymbol2=code0−code 1+code 2−code 3

softsymbol3=code0−code 1−code 2+code 3

Each of the above combinations of codes is reflected in the definition of a further (SF=4) soft data symbol array, d_{SF4}, as shown in FIG. 4, for the case where the histogram from the elements of d_{SF8}, has the form (0, 0, 0, 0, 31, 30, 30, 31). The first element of the SF=8 histogram which is greater than thresh₂ corresponds to the fifth code, thus KSF4 is set to 4, block 402. In a cycle of four elements, the codes are combined as above to give the elements of d_{SF4}, in terms of d_{SF16}, the output of the JD algorithm for SF=16, blocks 406, 408, 410 and 412. The cycle of definition of the elements of d_{SF4}, takes place within the for loop:—for (i=0; i=i+1; i=N), blocks 404, 414 and 416.

The data symbols of d_{SF4} are arranged so that the codes for each data symbol are gathered in order. In the example, the data symbols are arranged as follows: [symbol0:code0_{SF16}, code1_{SF16}, code2_{SF16}, code3_{SF16}, code4_{SF4}; symbol1:code4_{SF4}; symbol2:code4_{SF4}; symbol3:code4_{SF4}; . . . etc.] where code4_{SF4} is an SF4 spreading code.

The data symbols may then be reordered so all the symbols on a given code are grouped together and then demodulated and decoded in the normal way.

It will be understood that the method of present invention is not limited to the steps used in the example. Iteration of the method does not necessarily end when SF=4 has been assumed.

1. A method for despreading encoded transmissions using a plurality of spreading codes of unknown spreading factors, the method including the steps of:
a) selecting an initial spreading factor; and
b) applying the initial spreading factor to a joint detection algorithm in order to generate a first data symbol vector;
the method being characterised by further including the steps of:
c) post-processing the first data symbol vector at least once in order to determine the correct spreading factor for each of the plurality of spreading codes; and
d) despreading the encoded transmissions according to the spreading factors determined.

2. A method as claimed in claim 1, wherein a current spreading factor is set to be the initial spreading factor, a current data symbol vector is set to be the first data symbol vector, and values for a first threshold and for a second threshold are chosen, the post-processing step c) includes the following steps:
i) testing the magnitudes of elements of the current data symbol vector against the first threshold;
ii) for each spreading code, making a count of the number of elements of the first data symbol vector having magnitudes below the first threshold;
iii) creating a histogram, wherein each category corresponds to a given spreading code and wherein a value in each category corresponds to the count for the given spreading code;
iv) testing the values for each category of the histogram against the second threshold, whereby if the count for the given spreading code is less than the second threshold, the current spreading factor is determined to be the correct spreading factor for the given spreading code; and
v) if at least one count is greater than the second threshold, the following additional steps are taken: changing the current spreading factor to a subsequent spreading factor; generating the current data symbol vector from the first data symbol vector, the generation being dependent upon the subsequent spreading factor; and repeating steps iii) to v) until all spreading factors are determined.

3. A method as claimed in claim 2, wherein the subsequent spreading factor is lower than the initial spreading factor.

4. A method as claimed in any one of claims 1 to 3, wherein the initial spreading factor is sixteen.

5. A method as claimed in any one of claims 1 to 4, wherein the post-processing step c) further includes: checking whether each pair of spreading codes in the plurality of spreading codes has the same spreading factor and if different spreading factors are indicated for a given pair of spreading codes, assuming that only the lower spreading factor was transmitted.

6. An apparatus for despreading encoded transmissions using a plurality of spreading codes of unknown spreading factors, the apparatus including:
joint detection means, wherein a joint detection algorithm is applied to the encoded transmissions with an assumed initial spreading factor, the joint detection means generating a first data symbol vector;
post-processing means, wherein the first data symbol vector is post-processed in order to determine the correct spreading factor for each of the plurality of spreading codes; and
a decoding means, wherein the encoded transmissions are despread according to the spreading factors determined.

7. An apparatus as claimed in claim 6, wherein the post-processing means comprises:
initialising means, which: sets a current spreading factor to be the assumed initial spreading factor; sets a current data symbol vector to be the first data symbol vector; and sets the values for a first threshold and for a second threshold;
means for testing the magnitudes of elements of the current data symbol vector against the first threshold;
for each spreading code, means for making a count of the number of elements of the first data symbol vector having magnitudes below the first threshold;
means for creating a histogram, wherein each category corresponds to a given spreading code and wherein the value in each category corresponds to the count for the given spreading code;
means for testing the values for each category of the histogram against the second threshold, whereby if the count for the given spreading code is less than the second threshold, the testing means determines that the current spreading factor is the correct spreading factor for the given spreading code; and
if a given count is greater than the second threshold, the testing means determines that the current spreading factor is not the correct spreading factor for the spreading code corresponding to the given count.

8. An apparatus as claimed in claim 7, wherein the post-processing means further comprises:
means for changing the current spreading factor to a subsequent spreading factor; and
means for generating the current data symbol vector from the first data symbol vector, the generation being dependent upon the subsequent spreading factor.

9. An apparatus as claimed in claim 8, wherein the subsequent spreading factor is lower than the initial spreading factor.

10. An apparatus as claimed in any one of claims 6 to 9, wherein the initial spreading factor is sixteen.

11. An apparatus as claimed in any one of claims 6 to 10, wherein the post-processing means further includes:
means for checking whether each pair of spreading codes in the plurality of spreading codes has the same spreading factor and, if different spreading factors are indicated for a given pair of spreading codes, for assuming that only the lower spreading factor was transmitted.

12. An apparatus as claimed in any one of claims 6 to 11, where the post-processing means is implemented as software stored upon a conventional storage device for use in a conventional processing device.

13. An apparatus as claimed in any one of claims 6 to 12, where the joint detecting means is implemented as software stored upon a conventional storage device for use in a conventional processing device.

14. A computer storage device having software stored thereupon, wherein the software performs the method as claimed in any one of claims 1 to 5.
